(19) United States
(12) Patent Application Publication
(10) Pub. No.: US 2011/0289016 A1
(43) Pub. Date: Nov. 24, 2011

(54) Method of determining orderly liquidation value of patents

(76) Inventor: Robert W. Fletcher, Louisville, KY (US)

(21) Appl. No.: 12/800,587

(22) Filed: May 19, 2010

(51) Int. Cl. G06Q 40/00

(52) U.S. Cl. 705/36 R

(57) ABSTRACT

A Method for Determining the Orderly Liquidation Value of a Patent comprising the steps of: determining a revenue stream resulting from the manufacturer of products using a patented technology and using tangible and intangible assets in the production of said revenue stream; and, determining the contribution of the tangible assets to the revenue stream; and, determining the contribution of intangible assets to the revenue stream; and, subtracting the contributions of the tangible assets and intangible assets leaving only the contribution of the patented features of the products; and, dividing that patented contributed amount by a litigation risk factor to arrive at the orderly liquidation value of the patent.

### BACKGROUND OF THE INVENTION

As Intellectual Property becomes more and more a part of the asset value of corporations a greater need has arisen to value it realistically. Heretofore, methods of valuing patents have varied widely in their approach and consequently the final value attributed to a patent has varied widely. Previously, methods of valuation focused on comparable costs, not dissimilar to the method of valuing real estate based upon comparable values of similarly situated houses. The problem with the comparable cost method is no two patents are close enough in identity to truly be comparable. Also there is a paucity of transactions which can be used in the comparable cost method.

Another method of valuing patents is based upon the estimated cost of replacement or design around. While this method has a purpose, it does not take into account potential for licensing the patents or manufacture and sale of items within the scope of the patent claims which would generate profits.

In valuing a patent for the purposes of disposing of it for money in the environment of an orderly liquidation, the traditional valuation techniques are of little use. Such techniques include: 1) the market value where the patent value is predicted by comparing the market value of a company when it has the patent to an earlier point in time when it did not. Attempts have been made to determine the value of a company's publicly traded stock before and after it acquires one of its coveted patents and attribute the increase, if any, in value to the market's perception of the contributing value of the patent. Since it is difficult to determine and eliminate other factors that may be contributing to share price movement the market value approach is of limited use.

Other mathematical approximations such as the 25% rule—a suggestion that the value of the patent can be determined by first determining the profit derived from sale of the patented item and attributing 25% of that amount to the patent itself—adds little.

Typically sales are projected over a period of time and those sales amounts are discounted back to present value before applying the 25% rule.

Similarly, valuations which are based upon adopting the Black-Scholes model used in valuing puts and calls are of little help in determining the value of a patent in the context of an orderly liquidation. While the Black-Scholes mathematical model may have had usefulness in valuing a put or call it seems to have met with little success when the required variables are sought to be substituted with variables concerning such items as the development time for the patent, the estimated life of the claimed product and the like.

Later entrants into the market, such as the Competitive Advantage Valuation approach are enlightening for predicting the value of a patent in the hands of a going concern but nevertheless fall short when valuing a patent in the context of an orderly liquidation. Although some of the same considerations are used in both methods.

The most widely used method of valuing patents involves determining an income stream from either royalties or products produced under the patent, which streams are then discounted to present value. While these valuation schemes may be useful in valuing patents in the hands of a going concern they are not reliable in predicting a value which the patent may be expected to fetch in the context of an Orderly Liquidation such as, for example, in a patent auction.

### SUMMARY OF THE INVENTION

The present invention is a method of valuing a patent or a lot consisting of several patents. The method is comprised of three principal steps. The first is to determine a revenue stream resulting from the sale of products manufactured using the patented technology. The revenue stream should properly reflect market realities such as initial growth, a peak and subsequent tapering off resulting from non-infringing substitutes, alternative technologies and ever changing demand. Typically, the peak in sales performance occurs near the half way point in a product's life.

Each of the projected income amounts over the life of the product is discounted back to present value. The discount rate is typically selected to reward the entrepreneur for the risk in developing and successfully marketing or licensing the products sold. Typically, the streams are made up of known products of the technology which are discounted at the lowest discount rate of several, representing degrees of risk, which may be in the range of between four and twelve percent.

A second class of products is the anticipated products, the sales of which are also a component of the projected numbers. Sales of these anticipated products are discounted to present value at a higher discount rate, generally in the range of twelve to twenty percent. This higher discount rate can be understood to be the reward for the risk the entrepreneur has taken that this second class of products will actually be developed and successfully marketed.

Lastly, the amounts are contributed to by the speculative products. The speculative products are those that may not currently exist but are foreseen to be developed as commercialization of the known and anticipated products continues. The speculative products are discounted to present value at rates of between twenty and forty percent. The discount rate is again the reward to the entrepreneur earned in exchange for developing and marketing the highest risk, speculative products. This latter discount rate of between twenty and forty percent is equivalent to discount rates typically sought by venture capitalists investing in start-up companies.

Since revenue streams are produced by a coalescence of contributions from tangible and intangible assets, the second step of the present invention is to determine the contribution of the tangible assets to the streams. The present invention contemplates that the tangible assets be enumerated in balance sheet like form. The tangible assets are first valued according to generally accepted accounting principals (GAAP) accounting standards.

Preferably the book value of each of the tangible assets is set forth followed by a preset expected or required rate of return from that asset or investment expressed as a percentage. The more flexible the asset the more uses it has and therefore the lesser the rate of return on that asset since it can be easily deployed to support another cause. Frequently, the most flexible or transferrable asset is cash or liquid assets such as stocks and bonds. The rate of return for cash depends upon economic conditions but would range between three and fifteen percent. Other tangible assets such as land and buildings, vehicles and the like are measured in terms of their applicability to different projects and correspondingly assigned an appropriate required rate of return. These rates of return are multiplied by the asset value to establish the amount that the asset is expected to produce yearly. The projected revenue streams are reducing by each of the contributions of the tangible assets to arrive at the contribution of the non patent intangible assets.

Similarly, the required rate of return on intangible assets is calculated and likewise reduces the streams by that contribution. The determination of the value of the intangible assets is made according to the present invention by first determining the cost or replacement value where possible. But the value of other intangible assets has its own methodology. Specifically the value of management expertise is determined by first establishing the amount of time that a new manager is on staff before it can be said that he is contributing to the organization to the extent that he is no longer a cash drain. Typically, management personnel do not become positive contributors for the first three to six months of their employment. Thus if a manager is not productive for the first three months of his employment 25% of his annual salary is considered to be the investment in that manager. Summing the investment in the management team during the non productive portion of their employment gives a value which when multiplied by a required rate of return associated with it yields the amount which the intangible asset, the management team, must produce and will be credited as having contributed to the stream. Similarly, intangible assets such as a trained labor force are calculated by determining the portion of the annual salary which is invested in the laborer before he becomes productive.

In circumstances where the stream is one of many streams from many different products pro rata reductions are made in asset values so that each of the contributions of an asset is applicable for that particular product.

The “company reputation” intangible's contribution can be determined by recognizing that the company's reputation is a function of the amount of money spent in promoting the company through grants, donations and other charitable activities. The required amount of return for this intangible asset is likewise subtracted from the total. Subtracting all the contributions of from all non-patent intangibles in this step leaves the contribution from the patented features.

Typically, the value of trademarks and copyrights of the Intellectual Property asset is determined by the comparables method since both copyrights and trademarks more closely resemble fungible goods which then are comparable to like copyrights and trademarks held and sold by others. An alternative method of determining the value of trademarks can be accomplished by measuring advertising expenses based upon the presumption that advertising expenses go directly into building recognition of the company's trademarks.

Similarly, the value of copyrights can be measured by the comparable price method or can be determined by determining the cost of development of such things as brochures and promotional literature, computer software programs and instruction manuals, use and care manuals and quality control manuals. A good source of information which enables the practice of the method disclosed herein to be verified is to look to the balance sheets of competitive companies to determine averages of the various items enumerated above to the extent the information is available. Also guidance as to the proportional contribution to the revenue stream by the intangible assets can be ball parked by measuring the ratio of sales and general and administrative costs compared to all costs and expenses determined from the average of competitive company's income statements.

Having determined the contribution to the stream from copyright and trademark Intellectual Property assets the remainder is the contribution to derived because of the patented technology being employed.

Having calculated the contribution of the patented technology the last step is to reduce the contribution amount by the litigation risk factor. The litigation risk factor arises from the fact that competitors seeing the success of the patented technology are more likely to infringe the patents or in the alternative attack the products using other related patents or patents on subcomponents of the patented items. The method of determining the litigation risk factor is discussed in U.S. Pat. No. 7,536,331 which is incorporated herein by reference.

### DESCRIPTION OF THE DRAWINGS

FIG. 1 is a block illustration of the steps in determining the orderly liquidation value of a patent according to the present invention.

FIG. 2 is an illustration of a composite of discounted revenue streams for each of a sixteen year life of a patented product.

FIG. 3 is an illustration of required yields from tangible assets.

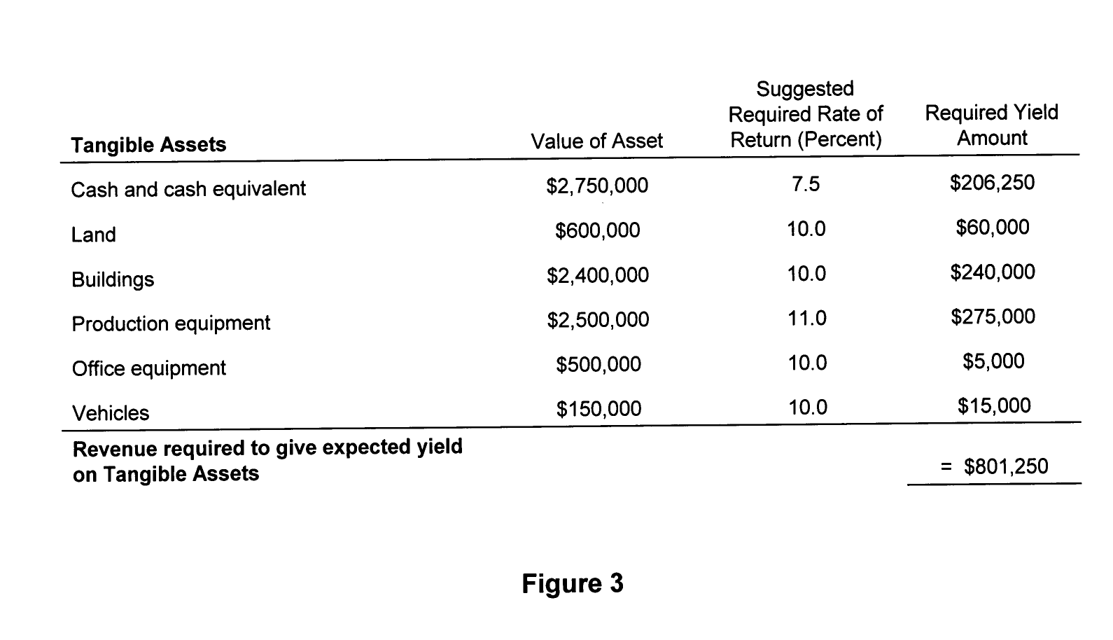

FIG. 4 is a table illustrating required yields from intangible assets.

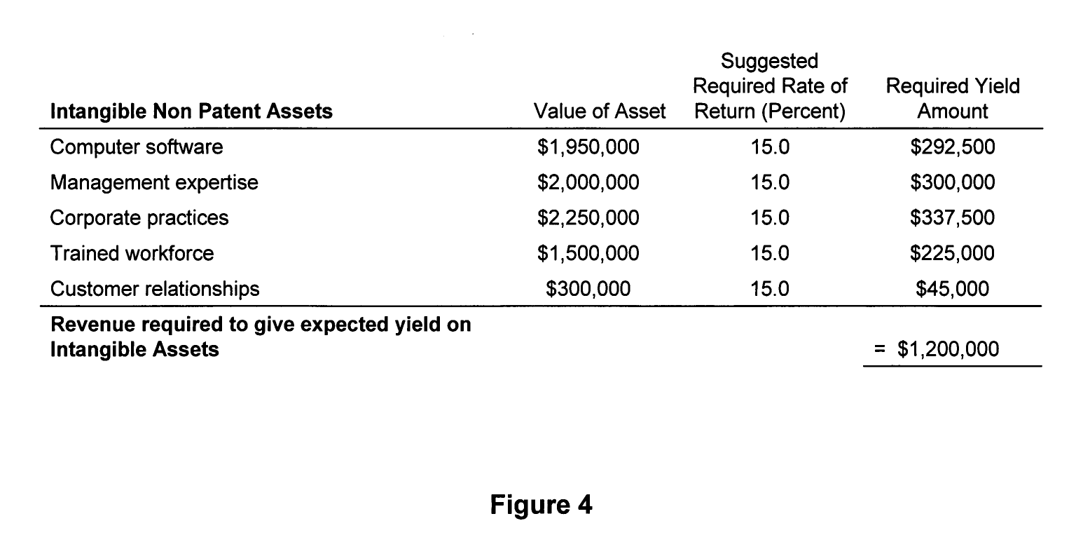

FIG. 5 is a table illustrating the calculations of an orderly liquidation value for a patent or a lot containing several patents.

FIG. 6 illustrates the contribution of tangible, intangible, copyrights, trademarks and patents to the streams of FIG. 2.

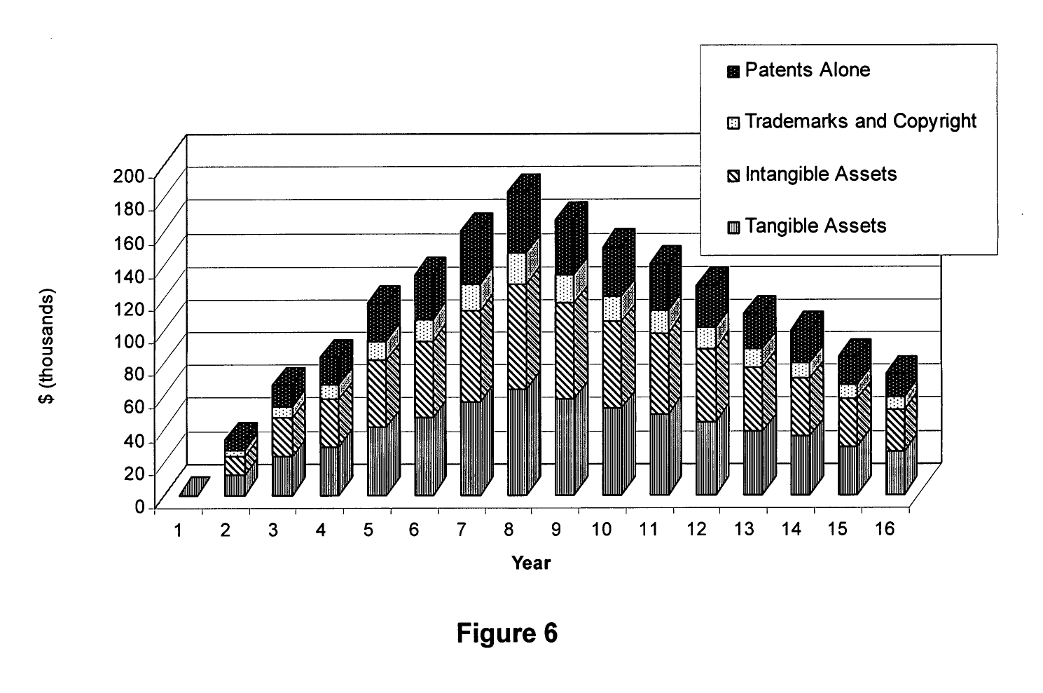

### DETAILED DESCRIPTION OF THE INVENTION AND PREFERRED EMBODIMENT

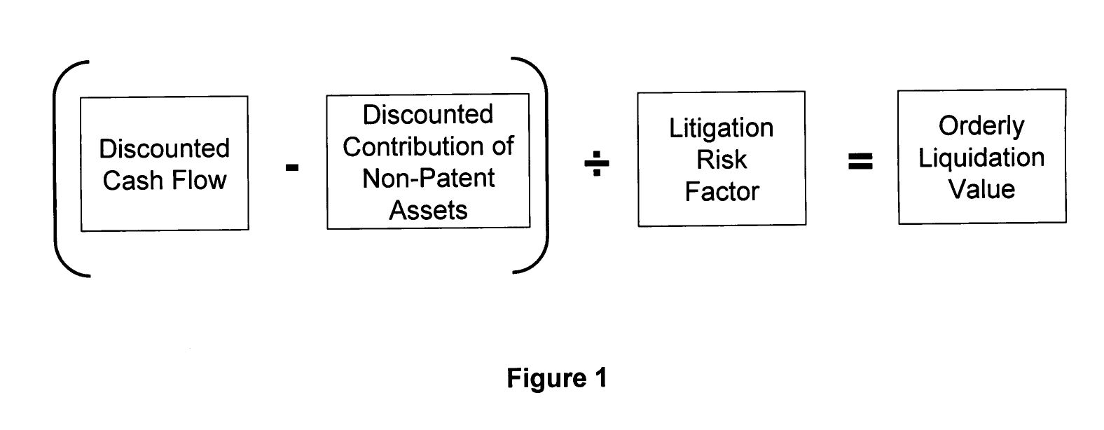

FIG. 1 describes the method of determining the orderly liquidation value of patents. The steps are to discount a cash flow stream arrived at by determining sales of known, anticipated and speculative products to arrive at the present value of the discounted cash flow streams. The next step is to determine the contribution of non-patent assets to the revenue streams and discount them. In this second step the contribution of tangible assets to the revenue stream must be subtracted then the contribution of non IP in-tangible assets must be subtracted and the contribution of any copyrights and trademarks must be subtracted. The remainder is the contribution of the patent covered features. That contribution is divided by the litigation risk factor which results from the increased possibility of litigation due to the increased market exposure and thus visibility of the product containing the patent covered features.

Specifically, two perils are involved which contribute to the increase in potential litigation and thus give a litigation risk factor greater than 1. One of the perils is the fact that the product containing the patent covered features becomes more highly visible to the general public thus any patent holder having related patents on, for example, components of the product containing the patent covered features may discover infringement issues and bring a lawsuit. Similarly, the success of the product with patent covered features will attract competitors some of which may choose to infringe or attempt to design around but none the less give rise to charges of infringement. The result is the orderly liquidation value of the patent or lot containing several patents. The orderly liquidation value calculated by the method of this invention is a value which predicts with a high degree of accuracy the amount of money which the patent or patent lot will fetch at public auction or private sale.

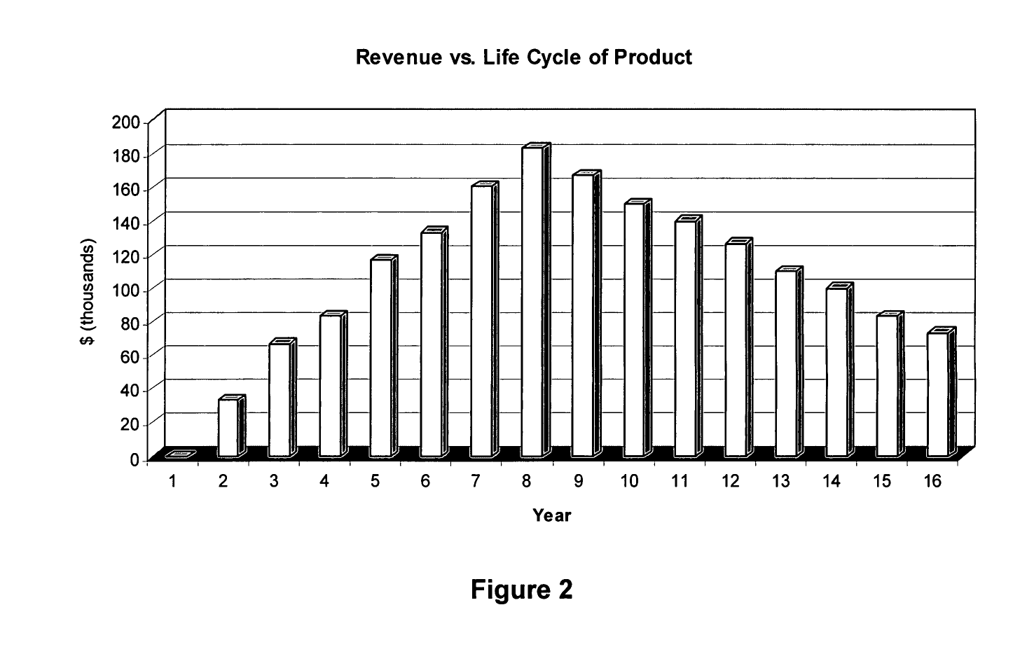

FIG. 2 shows in bar graph illustration of the revenue streams. The product being sold is a medical device which has superior characteristics and features compared to medical devices currently in use. The known product is a medical device which is operably positioned in vivos by a surgical procedure. An anticipated product is a medical device useful under less severe circumstances. Speculative products are associated products commonly used in conjunction with the medical device in the surgical procedure used to put the medical device into place.

In valuing IP using the Orderly Liquidation Valuation Technique a summary of the technology is required. This summary should be the basis for a platform upon which the analysis of the technology is built. A discussion of the end uses for the technology is appropriate sighting sources and statistically data with a general narrowing of the discussion to focus upon the benefits of the specific technology in question. A discussion of the developing alternatives is also essential in this case. A brief description of each of the competitors and their market share is appropriate. When discussing the technology any competing technologies should be mentioned. The benefits of such competing technologies can be addressed in broad, general terms.

Later on it will be necessary to complete a technical orientation reviewing the technology and relevant patents. Wikipedia and Google searches are an excellent starting point for this orientation. Also it will be necessary to communicate with the client and/or other experts in completing the technology summary. Table I gives a breakdown of the tasks to be performed in reviewing the technology.

TABLE I
Breakdown Of Tasks Required By Product:

| | |
|---|---|
| TASK 1 | |
| Technical | Review client's relevant information re: patents/technology |
| Orientation | Production feasibility |
| Technical | Analyze test results relative to market functionality |
| Review | Technical data study-Is it complete-Timing |
| | Performance comparisons of competitors |
| Preliminary | Summary analysis, of above and legality, regulatory, social |
| Assessment | issues |
| TASK 2 | |
| Patent Study | Review patent claims |
| | Study patent file history used for underwriting |
| | Conduct validity study |
| | Investigate bars to enforcement |
| TASK 3 | |
| Production | Cost of development |
| Study | Cost of commercialization |
| | Payback period based upon profitability |
| TASK 4 | |
| Market | Identify markets known, anticipated, speculative products |
| Identification | Analyze and prioritize markets by size and geographic |
| and Analysis | distribution |
| | Identify license/production candidates |
| | Establish a product life and price for each of the types of |
| | products |
| | Address stability of demand |
| Industry | Evaluation interviews with industry experts |
| Intelligence | Internet search for appearance, functionality, cost etc of |
| | compatible items |
| Cost/Benefit | Evaluation of potential application (economic, costs, |
| Analysis | benefits, etc.) |
| | Determine the learning curve for operation or use |
| Competitor | Analysis of each competitor in the market, complete |
| Assessment | Table I for each |
| | Analysis of cost/benefit for each competitor |
| | Analysis of industry intelligence for each competitor |
| | Do a patent profile on the patents of each competitor |

Observations should be made to determine whether the market is emerging, developed or mature and should include a trend analysis which takes into consideration the life of the product as well as likely competitive responses with alternate devices. Such a sales trend analysis may take the form of FIG. 2 where the peak of sales may correspond to the highest point in the product's estimated life cycle with an ever-diminishing number of sales thereafter. Reference is made to FIG. 2 which illustrates this stream.

In addition to Wikipedia and Google, several other websites have proven to be repositories of useful information. For example, Hoovers (a D&B company) at www.hoovers.com/free/ is a source of information on the company requesting the valuation as well as its competitors. The USPTO.gov website is a source of information concerning patents and their prosecution histories. The Orange Book of approved drug products is also a great source of information about approved drugs with their therapeutic equivalence evaluations. The source can be searched by active ingredient, proprietary name, application number or applicant holder as well as by patent. This source should not be overlooked when dealing with any drug product. It is updated daily. Another useful site is the International Trademark Association's site: www.inta.org. This site gives the websites of all the National Intellectual Property offices as well.

### Determination of a Stream

Determining the revenue stream in the Orderly Liquidation Valuing process three steps are involved. The first is to determine the possible revenue streams available through sales or use of the patented commodity. Generally, the analysis is to look at known uses or products which have a high degree of probability of being profitable.

The second is looking to anticipated products or uses which are more speculative but which have a relatively high degree of certainty with respect to use or production. Generally, these anticipated uses or products are within the same general art area and represent merely an expansion to fill different yet similar markets or needs. Little or no revision of the original need be made.

Lastly, there are the more uncertain speculative uses or products. These products are the least likely to be developed and therefore carry the highest discount rate. Such products or processes could be a process of making water-based organic emulsions to not only allow production of water-based paints but to also allow production of water-based coatings for, for example, reducing the friction on finely honed blades and cutting devices.

These various cash flow streams should be compiled based upon a reasonable distribution approximation as shown in FIG. 2 using the procedures from Table II. The above discount rate will vary from valuation to valuation and should take into consideration items such as the economic climate uncertainty, the capital requirements and the cash flow duration.

TABLE II
Present Value of an Income Stream

| | |
|---|---|
| [symbol] | |
| | Calculate a cash flow stream |
| | based upon sales assigned to known |
| | products, anticipated products and |
| | speculative products |
| | Determine required discount rates |
| | Set a discount rate by referring to |
| | nature of the product |

[symbol]

indicates data missing or illegible when filed

It is also important to determine the size of the market for the patented device, the number of competitors and their particular financial characteristics. The projection of sales is only the beginning.

Table III gives an example of the known, anticipated and speculative sales projections for the sales of Angioplasty Trap Barrier Device. In the case of Table III it will be noted that three years of post historic data were used as the basis for the regression curves initially. Forward projections begin in year 1 and thereafter.

TABLE III
Example of table showing sales of known, anticipated and speculative products
Angioplasty Procedures - Known or Estimated from Historical Data

| | | | | | Past | Past | Past | | | | | | | |
|---|---|---|---|---|---|---|---|---|---|---|---|---|---|---|
| | ICD-9-CM# | | Procedure (000's) | Year | 3 | 2 | 1 | 1 | 2 | 3 | 4 | 5 | 6 | 7 |
| | | 36.00 | PTCA - | | 306 | 348 | 390 | 432 | 474 | 517 | 559 | 601 | 643 | 685 |
| Known | {open oversize brace} | | Coronary arteries | | | | | | | | | | | |
| | | 36.01 | PTCA - Single | | 264 | 310 | 357 | 403 | 450 | 496 | 543 | 589 | 636 | 682 |
| | | | coronary artery | | | | | | | | | | | |
| | | 36.02 | PTCA - With | | 16 | 19 | 22 | 25 | 28 | 32 | 35 | 38 | 41 | 44 |
| | | | Thrombolytic Age | | | | | | | | | | | |
| | | 36.03 | PTCA - Open Chest | | 10 | 11 | 13 | 15 | 17 | 19 | 20 | 22 | 24 | 26 |
| Anticipated | {open oversize brace} | 36.05 | PTCA - Multiple | | 39 | 49 | 60 | 70 | 81 | 91 | 102 | 112 | 123 | 133 |
| | | | Vessels | | | | | | | | | | | |
| | | 36.09 | PTCA - Laser | | 0 | 0 | 0 | 0 | 0 | 0 | 0 | 0 | 0 | 0 |
| | | 39.59 | PTCA - Peripheral | | 67 | 75 | 84 | 93 | 102 | 111 | 119 | 128 | 137 | 146 |
| | | | Arteries | | | | | | | | | | | |
| | | | Totals: | | 702 | 812 | 926 | 1,038 | 1,152 | 1,266 | 1,378 | 1,490 | 1,604 | 1,716 |
| Related Sales (millions) | | | | | | | | | | | | | | |
| | | Balloon | | | $350 | $406 | $463 | $519 | $576 | $632 | $688 | $745 | $801 | $858 |
| | | Catheters | | | | | | | | | | | | |
| Speculative | {open oversize brace} | Accessories | | | $158 | $183 | $208 | $234 | $259 | $284 | $310 | $335 | $361 | $386 |
| | | Other | | | $14 | $16 | $19 | $21 | $23 | $25 | $28 | $30 | $32 | $34 |
| | | Totals: | | | $522 | $605 | $690 | $774 | $858 | $941 | $1,026 | $1,110 | $1,194 | $1,278 |

The discount rates should be those discount rates sought by venture capitalists investing money in non-high-tech or non-Intellectual Property related ventures. Since the patent inverse risk factor used in the third step of this valuation will take into account the uncertainties of the patent to be valued, the present value of the income stream is typically calculated by using a discount factor of ten percent (10%) for the known products, twenty percent (20%) for the anticipated products and thirty five percent (35%) for the speculative products. Each of these percentages represents the uncertainty of the income stream actually developing. The thirty five percent rate is the rate which venture capitalists look for on speculative products in ventures financed with risk capital. Similarly, a purchaser in an Orderly Liquidation would be speculating just as the venture capitalists do and therefore would be looking for the same discount rate.

To recap, the task to be completed is a determination of the present value of an income stream which should have the general steps of the example shown in Table II.

Next it is important to determine the characteristics of the assets involved in the production of the income stream developed. The typical classification of assets is tangible, intangible, non-patent and patent-related assets.

Contribution to the Stream from Tangible Assets

Having valued the cash flow from sales of products covered by the patent in question, it is now important to determine how much value should be attributed to the patent itself. This determination is necessary since the use of a number of intangible and tangible assets contribute to the successful manufacture and sale of a patented product. Not all of the value can be attributed directly to the patent.

For example, tangible assets such as land, building, equipment and the like all facilitate the manufacture of products and should be attributed some role. If the practitioner looks at a royalty stream as opposed to sales of product the proportioning of value attributable to tangibles has already been accomplished. Otherwise a rough rule of thumb that can be used is attribute the contribution of land, buildings and equipment and other tangibles can be determined by multiplying product sales times a fraction whose numerator is the book value of the entity in question and whose denominator is the market value. The product of the above multiplication narrows the sales number to the contribution from intangible property.

Frequently however, there is no established market value for the entity in question. Thus for closely held corporations, startups and non-traded entities, an alternative approach is needed.

Table IV is used to reverse calculate the contribution of the patent to the revenue stream by reducing those streams by the amount of contribution of the fixed assets determined to be needed to successfully produce the patented items. These analyses can be made by studying competitors in conjunction with the company currently owning the patent being valued. Table IV can be used as a starting point for determining the approximate values for each of the items which can be obtained either from competitor information or from known industry standard information or most preferably, of course, from the applicant himself. The stated values for the various assets such as cash (the critical mass of cash needed), land, buildings (or an equivalent lease therefore), production equipment, office equipment and vehicles (if needed) are all readily ascertainable numbers. When calculated by multiplying the value times the rate of return required the yield amount is obtained. This required yield amount is the amount of money which reduced to present value must be deducted from the income stream present value to arrive at the remainder which is the contribution of the intangible property.

TABLE IV

| | | Suggested | |
|---|---|---|---|
| | | Required | |
| | | Rate of | Required |
| | Value of | Return | Yield |
| | Asset | (Percent) | Amount |
| Tangible Assets | | | |
| Cash and cash equivalent | — | 7.5 | — |
| Land | — | 10.0 | — |
| Buildings | — | 10.0 | — |
| Production equipment | — | 11.0 | — |
| Office equipment | — | 10.0 | — |
| Vehicles | — | 10.0 | — |
| Intangible Non Patent Assets | | | |
| Computer software | — | 15.0 | — |
| Management expertise | — | 15.0 | — |
| Corporate practices | — | 15.0 | — |
| Trained workforce | — | 15.0 | — |
| Customer relationships | — | 15.0 | — |
| Subtotal | | | |

| | |
|---|---|
| Present Value of Projected | |
| less required to give expected | ( ) |
| yield on Assets | |
| contribution of Intellectual | |
| Property | |

In the ongoing valuation process it is frequently helpful to construct an income statement such as that shown in Table V which will enable a better understanding of the competition and the relative cost ratios involved for the particular industry in which the patented technology falls. Several of these income statements can be prepared each for one competitor thus giving a better feel for the various parameters involved. Later in the valuation it will become apparent that several of the costs can be used as approximations for the contribution to the income streams generated according to the example of Table I from several of the intangible non-patent assets.

The competitors must be analyzed to determine typical gross sales, gross income after General and Administrative (G&A) i.e., sales commissions and other costs of procuring the business such as licensing, registration and the like. Table V gives a typical income statement that can be used as a guideline to determine the various costs. The percentages are for a small entity.

TABLE V

| s | Current Month | % | Year to Date | % |
|---|---|---|---|---|
| Sales of Known | $ | | $ | |
| Products | 0.00 | 0.00 | 0.00 | 0.00 |
| Sales of Anticipated | $ | | $ | |
| Products | 0.00 | 0.00 | 0.00 | 0.00 |
| Sales of Speculative | $ | | $ | |
| Products | 0.00 | 0.00 | 0.00 | 0.00 |
| Management Fees | 0.00 | 0.00 | 0.00 | 0.00 |
| Commission Income | 0.00 | 0.00 | 0.00 | 0.00 |
| Late Fees | 0.00 | 0.00 | 0.00 | 0.00 |
| Interest Income | 0.00 | 0.00 | 0.00 | 0.00 |
| Other Income | 0.00 | 0.00 | 0.00 | 0.00 |
| Finance Charge Income | 0.00 | 0.00 | 0.00 | 0.00 |
| Shipping Charges | 0.00 | 0.00 | 0.00 | 0.00 |
| Reimbursed | | | | |
| Fee Refunds | 0.00 | 0.00 | 0.00 | 0.00 |
| Fee Discounts | 0.00 | 0.00 | 0.00 | 0.00 |
| Totals | 0.00 | 0.00 | 0.00 | 0.00 |
| Cost of Sales | | | | |
| Cost of Sales | 0.00 | 0.00 | 0.00 | 0.00 |
| Cost of Sales-Salaries | 0.00 | 0.00 | 0.00 | 0.00 |
| and Wage | | | | |
| Total Cost of Sales | 0.00 | 0.00 | 0.00 | 0.00 |
| Gross Profit | 0.00 | 0.00 | 0.00 | 0.00 |
| Expenses | | | | |
| Default Purchase | 0.00 | 0.00 | 0.00 | 0.00 |
| Expense | | | | |
| Accounting Services | 0.00 | 0.00 | 0.00 | 0.00 |
| Advertising Expense | 0.00 | 0.00 | 0.00 | 0.00 |
| Amortization Expense | 0.00 | 0.00 | 0.00 | 0.00 |
| Bad Debt Expense | 0.00 | 0.00 | 0.00 | 0.00 |
| Bank Charges | 0.00 | 0.00 | 0.00 | 0.00 |
| Cash Over and Short | 0.00 | 0.00 | 0.00 | 0.00 |
| Charitable | 0.00 | 0.00 | 0.00 | 0.00 |
| Contributions Exp | | | | |
| Depreciation Expense | 0.00 | 0.00 | 0.00 | 0.00 |
| Filing Fees | 0.00 | 0.00 | 0.00 | 0.00 |
| Inspections-Bldg. | 0.00 | 0.00 | 0.00 | 0.00 |
| Insurance Expense | 0.00 | 0.00 | 0.00 | 0.00 |
| Interest Expense | 0.00 | 0.00 | 0.00 | 0.00 |
| Loan Service Exp.- | 0.00 | 0.00 | 0.00 | 0.00 |
| Monthly | | | | |
| Legal and Professional | 0.00 | 0.00 | 0.00 | 0.00 |
| Expense | | | | |
| Licenses Expense | 0.00 | 0.00 | 0.00 | 0.00 |
| Loan Appln Fees | 0.00 | 0.00 | 0.00 | 0.00 |
| Loss on NSF Checks | 0.00 | 0.00 | 0.00 | 0.00 |
| Maintenance Expense | 0.00 | 0.00 | 0.00 | 0.00 |
| Office Expense | 0.00 | 0.00 | 0.00 | 0.00 |
| Payroll Tax Expense | 0.00 | 0.00 | 0.00 | 0.00 |
| Penalties and Fines Exp | 0.00 | 0.00 | 0.00 | 0.00 |
| Other Taxes | 0.00 | 0.00 | 0.00 | 0.00 |
| Taxes-Property | 0.00 | 0.00 | 0.00 | 0.00 |
| Postage Expense | 0.00 | 0.00 | 0.00 | 0.00 |
| Rent or Lease Expense | 0.00 | 0.00 | 0.00 | 0.00 |
| Repairs Expense | 0.00 | 0.00 | 0.00 | 0.00 |
| Supplies Expense | 0.00 | 0.00 | 0.00 | 0.00 |
| Telephone Expense | 0.00 | 0.00 | 0.00 | 0.00 |
| Wages Expense | 0.00 | 0.00 | 0.00 | 0.00 |
| Utilities Expense | 0.00 | 0.00 | 0.00 | 0.00 |
| Other Expense | 0.00 | 0.00 | 0.00 | 0.00 |
| Purchase Disc- | 0.00 | 0.00 | 0.00 | 0.00 |
| Expense Items | | | | |
| Gain/Loss on Sale | 0.00 | 0.00 | 0.00 | 0.00 |
| of Assets | | | | |
| Property Taxes | 0.00 | 0.00 | 0.00 | 0.00 |
| Total Expenses | 0.00 | 0.00 | 0.00 | 0.00 |
| Net Income | $ | | $ | |
| | 0.00 | 0.00 | 0.00 | 0.00 |

The value of corporate practices is a value of known ways of doing business which have been developed by the corporation over the course of years. Its value takes the form of purchase order forms, indemnification forms, production manuals, quality control standards and the like. This number is calculated as being 10% of the annual management salaries if reference to Table IV is not available. Having values for each of the tangible and intangible non-patent assets permits the calculation of the required yield amounts which are then subtracted from the net present revenue above to determine the contribution to the stream from the patent or patents.

Contribution to the Stream from the Patent, i.e. the Value of the Patent

Subtracting the income requirements for all of the assets needed to produce the stream determined in step one results in a number which includes only the amount produced by the Intellectual Property being valued. In our analysis we have taken into account the value of copyright when valuing the cost of the trained workforce and management since the origin of the copyrights for a typical manufacturing company is from this source. Of course exception must be made in the case where copyrights are the prime IP to be valued. Similarly, the contribution of trademarks and company reputation can be determined by exploring the costs involved in creating them. Very typically the advertising and promotion costs as a percent of total costs gives a suitable fraction to be applied against the product of the multiplication based upon the values in Table IV. The end result is then the value of the patent contribution on a discounted basis to the income stream of FIG. 2.

### Adjustments to Patent Value

As the final step in the patent valuation process take into consideration the litigation risk and legal strength associated with the patent itself. This is done by using the standard legal risk evaluation technique which is also used to calculate the risk associated with enforcing patents for IP abatement insurance.

The litigation risk is assessed by considering the entire patent landscape including the class and sub-class of the patent itself. Very typically considerations such as patent strength, the patent business relationship, the competitive environment and patents held by competitors, the litigation history both of the patent owner as well as competitors and the insurance history are important considerations. The considerations for adjusting the patent based upon the patent strength and litigation risk assessment are the same considerations that are given in underwriting a patent for Intellectual Property Enforcement Insurance and when so underwritten a final adjustment factor is used to adjust the patent value.

### VI. The Final Value

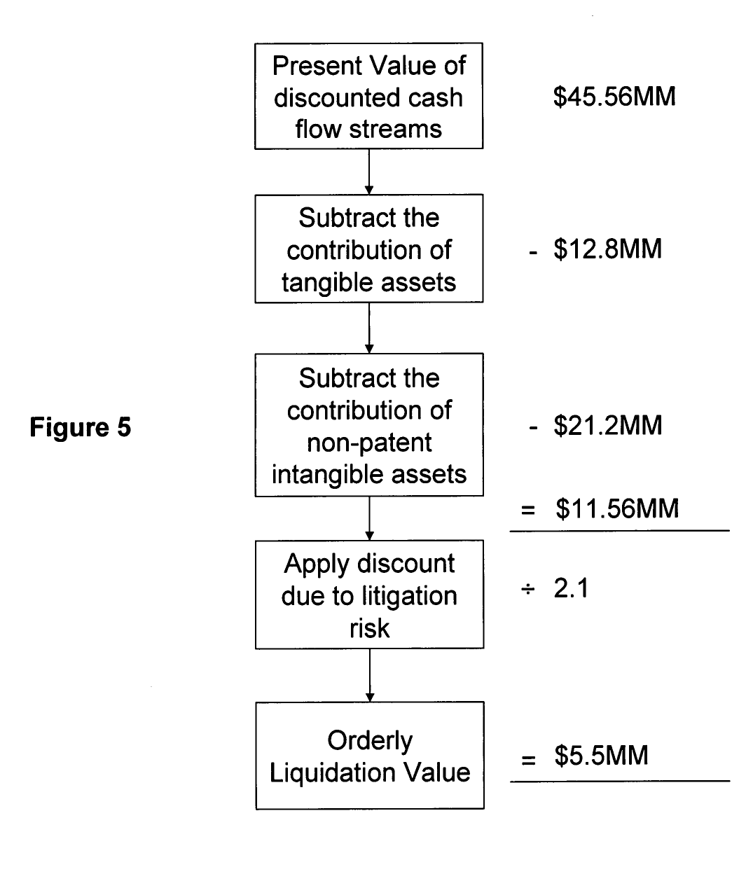

The risk factor suggests that the patent being valued is more likely to be involved in a lawsuit and possibly to be found invalid. The value of the patent calculated thus far must be adjusted by dividing the risk factor into the patent value to adjust for these risks. Thus the final valuation for the patent is now calculated as shown in FIG. 5 to give a final number. In the case of an aggregate value for all patents each patent can be underwritten individually and the risk factors can be used to proportion the aggregate value between patents.

The final valuation then is determined according to the final analysis which is shown and computed as follows:

| Present value of discounted cash flow streams | 45.56 | |
|---|---|---|
| Less the contribution of tangible assets | − 12.80 | |
| Less the contributions of intangible non-patent assets | − 21.20 | |
| Contribution of patent-covered features | = 11.56 | |
| Discounted by the breadth, and enforceability of | | |
| the patent(s) being valued-inverse of patents | 2.1 | |
| Final Adjustment Factor (FAF) | FAF | |
| Order Liquidation Value | 5.5 | MM |

Having thus described the invention, what is claimed is:

1. (canceled)

2. A method for determining the orderly liquidation value of a patent comprising the steps of:
determining a revenue stream resulting from the manufacturer of products using a patented technology and using tangible and intangible assets in the production of said revenue stream,
determining the contribution of the tangible assets to the revenue stream,
determining the contribution of intangible assets to the revenue stream,
subtracting the contributions of the tangible assets and intangible assets leaving only the contribution of the patented features of the products,
dividing that patented contributed amount by a litigation risk factor to arrive at the orderly liquidation value of the patent.
